(19) United States
(12) Patent Application Publication
(10) Pub. No.: US 2010/0075130 A1
(43) Pub. Date: Mar. 25, 2010

(54) Controlled fabrication of hierarchically branched nanopores, nanotubes, and nanowires

(75) Inventors: Guowen Meng, Hefei (CN); Pulickel M. Ajayan, Clifton Park, NY (US); Yung Joon Jung, Troy, NY (US)

Correspondence Address: FOLEY AND LARDNER LLP;SUITE 500, 3000 K STREET NW, WASHINGTON, DC, 20007, US

(73) Assignee: Rensselaer Polytechnic institute

(21) Appl. No.: 11/435,294

(22) Filed: May 17, 2006

Related U.S. Application Data
(60) Provisional application No. 60/681,743, filed on May 17, 2005.

(51) Int. Cl. B29D 22/00; B29B 11/14; C25B 3/02

(52) U.S. Cl. 428/315.5; 428/367; 264/344; 428/364; 216/56; 205/50; 977/842; 977/754

(57) ABSTRACT

A branched nanostructure, includes at least one of (a) a stem and at least two levels of branches; or (b) a stem connected to three of more branches; or (c) a nanowire nanostructure comprising a stem and two or more branches; or (d) a stem connected to two or more branches, where the stem and the branches comprise a different material composition or structure.

### CROSS-REFERENCE TO RELATED PATENT APPLICATIONS

This application claims priority to U.S. Provisional Patent Application No. 60/681,743, filed. May 17, 2005, which is incorporated herein by reference in its entirety.

### STATEMENT REGARDING FEDERALLY SPONSORED RESEARCH OR DEVELOPMENT

This invention was made with U.S. government support under the National Science Foundation grant No. ______. The United States government may have rights in this invention.

### FIELD OF THE INVENTION

The present application relates generally to nanostructures such as nanowires and carbon nanotubes and more particularly to branched nanostructures.

### BACKGROUND

The design and controlled synthesis of complex nanostructures, such as nanowires and carbon nanotubes (“CNTs”) will impact developments in nanotechnology applications. The prior art synthesis approaches, however, limit the degree of complexity that can be controllably configured into these nanostructures. Fabrication inside rationally designed porous templates, such as anodic aluminum oxide (“AAO”) templates, may be used to produce nanostructure morphologies. However, it is believed that only linear nanostructures and Y-branched CNTs (i.e., carbon nanotubes having one stem and two branches) have been grown inside the rationally designed porous templates (see Li, J., Papadopoulos, C. & Xu, J. (1999) Nature 402, 253-254 and Papadopoulos, C., Rakitin, A., Li, J., Vedeneev, A. S. & Xu, J. M. (2000) Phys. Rev. Lett. 85, 3476-3479, both incorporated herein by reference in their entirety).

### SUMMARY

One embodiment of the invention includes a branched nanostructure, includes at least one of (a) a stem and at least two levels of branches; or (b) a stem connected to three of more branches; or (c) a nanowire nanostructure comprising a stem and two or more branches; or (d) a stem connected to two or more branches, where the stem and the branches comprise a different material composition or structure.

### BRIEF DESCRIPTION OF THE DRAWINGS

FIG. 1A is a schematic side cross-sectional view of steps in a process according to one embodiment of the invention.

FIG. 1B is schematic illustration of nanostructures according to embodiments of the invention.

FIGS. 2A-2E, 3A-3D, 4A-4C, 5A-5C, 6A-6C and 7A-7B are SEM images of nanostructures according to embodiments of the invention.

FIGS. 3E-3F and 8A-8F are TEM images of nanostructures according to embodiments of the invention.

### DETAILED DESCRIPTION

The embodiments of the invention provide a generic synthetic approach to rationally design multiply connected and hierarchically branched nanopores inside nanopore arrays in a template material, such as inside anodic aluminum oxide templates. By using these nanopores or nanochannels, a large variety of branched nanostructures are fabricated, and which are believed to be more complex than prior art nanostructures. These nanostructures include carbon nanotubes and nanowires. The term nanowire includes metal, semiconductor, conductive polymer (such as polyaniline, polypyrrole, etc.), insulating polymer or other insulating material nanowires, but excludes hollow carbon nanotubes. The term nanostructures also includes quasi-nanotube or quasi-nanowire structures, such as nanohorns and nanowhiskers.

The nanostructures of the embodiments of the invention may include several hierarchical levels of multiple branching or more than two branches for each stem. The number and frequency of branching, dimensions, and the overall architecture are controlled precisely through pore design and templated assembly. The technique provides a powerful approach to produce nanostructures of greater morphological complexity, which could have far-reaching implications in the design of future nanoscale systems.

The branched nanostructures of the embodiments of the invention may comprising at least one of: (a) a stem and at least two levels of branches, or (b) a stem connected to three of more branches, or (c) a nanowire nanostructure comprising a stem and two or more branches, or (d) a stem connected to two or more branches, wherein the stem and the branches comprise a different material composition or structure. The nanostructure may contain any combination of one, two, three or all four of above features. The nanostructure is preferably formed by a method which includes forming the nanostructure in a branched nanopore located in a template material, and selectively removing the template material.

The term “stem” as used herein refers to the part of the nanostructure which is formed in the nanopore before the branches. The term “branches” refer to the parts of the nanostructure which are directly or indirectly connected to the stem. For example, in a nanostructure that has two levels of branches, each of the branches in the first level are directly connected to the stem and each of the branches in the second level are connected to one of the branches in the first level. Thus, the branches in the second level are indirectly connected to the stem through the branches of the first level. Preferably the stem is connected to more than one branch of the first level, and each branch of the first level is connected to more than one branch of the second level. It should be noted that the nanostructure may contain only one level of branches.

In one embodiment, the nanostructure contains three or more branches connected to the stem. In another embodiment, the nanostructure contains a stem and two or more levels of branches, where the stem may be connected to two or more branches in the first level, and each branch in the first level is connected to two or more branches in the second level. If desired, the embodiments may be combined such that the nanostructure contains a stem and two or more levels of branches, where the stem may be connected to three or more branches in the first level, and/or each branch in the first level is connected to three or more branches in the second level.

It should be noted that the term “stem” is not limited to the bottom most part of the nanostructure. For example, each branch located in the middle of the nanostructure can be considered to be a stem with respect to the higher level branches to which it is connected. Thus, a nanostructure can have several stems. Furthermore, the original stem of the nanostructure may be removed, leaving a plurality of branches, the lowest of which becomes the new stem.

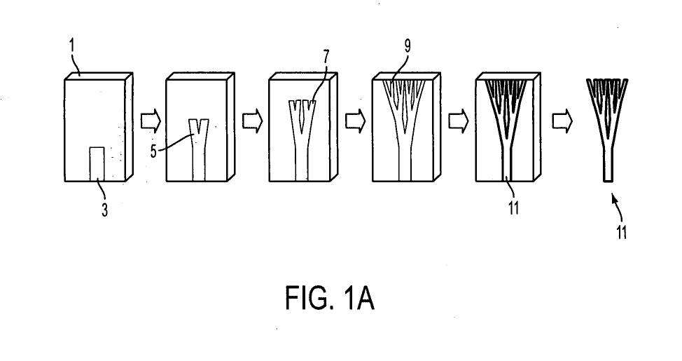

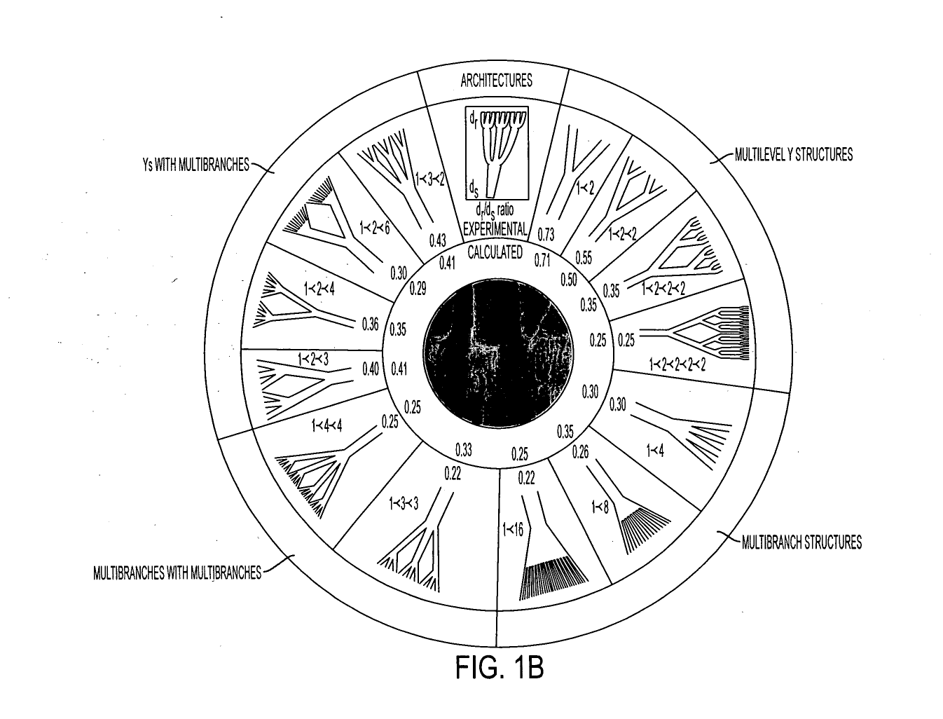

FIG. 1A shows the schematic of the steps in the fabrication process of the nanostructures according to one embodiment of the invention. As shown in the first four steps FIG. 1A, the pores with controlled architectures are first developed inside the template material by consecutive steps of anodization. For example, the stem pores 3 are first formed in the template material 1. The first 5, second 7, and third 9 level branch pores are then formed in contact with the stem pores in the template material 1. The pores 3, 5, 7 and 9 are then used as a “mold” to “cast” branched nanostructures 11, such as nanotubes and nanowires, of complex geometries as shown in the fifth step in FIG. 1A. The templates 1 then are removed by selective etching to recover the nanostructures structures 11, as shown in the last step of FIG. 1A.

Thus, a method of making the multilevel nanopore array includes anodically oxidizing the template material 1 at a first voltage to form a first level of stem nanopores 3 in the template material. The method further includes anodically oxidizing the template material 1 at a second voltage lower than the first voltage to form a second level of branch nanopores 5 connected to the first level of stem nanopores 3. The method further includes anodically oxidizing the template material 1 at third voltage lower than the second voltage to form a third level of branch nanopores 7 connected to the second level of branch nanopores 5, and so on until a desired number of levels is formed.

The nanopore array formed by the method of the first four steps of FIG. 1A includes the template material and two or more levels of pores. The first level of pores comprises stem pores 3. A second level of pores comprise branch pores 5, such that at least two branch pores 5 in the second level of pores are connected to each stem pore 3 in the first level of pores. The array further includes at least one of (a) a third level of pores comprising branch pores 7, such that at least two branch pores 7 in the third level of pores are connected to each branch pore 5 in the second level of pores, and/or (b) at least three branch pores 5 in the second level of pores which are connected to each stem pore 3 in the first level of pores.

FIG. 1B schematically illustrates different architectures that have been synthesized for CNTs using the templates 1. The present inventors believe, to the best of their knowledge, that such a wide range of complex nanopore, nanotube, and nanowire structures, with multiple junctions and branches, has not been fabricated in the prior art. To denote this broad spectrum of architectures with multiple levels of branching, the following notation is used: l [symbol] n [symbol] m, where “ [symbol] ” stands for the junction where the branching takes place, and n or m stands for the number of branches produced. The simplest case of a Y-junction thus is denoted as a 1 [symbol] 2 structure. Thus, the first number is the stem, the second number is the number of branches in the first level of branches, the third number is the number of branches in the second level of branches, and so on.

The structures in FIG. 1B are categorized based on four different hierarchies of branching of stems: multiple generations or levels of Y-branching from one stem, multiple branching (such as three or more branches) from individual stems, combination of Y-branching with each branch undergoing multiple-branching (or reverse), and a combination of multiple branching with each branch developing multiple branches. Examples of structures, which have been experimentally made, are drawn in the schematic. As seen in FIG. 1B, the diameters of the nanotube segments progressively decrease as the branching continues. These diameters are theoretically related to the ratios of the anodizing voltages consecutively used to divide pores inside the AAO. The theoretical values of the diameter ratios (smallest, to largest diameter on each structure) are shown by the fractional numbers in each of the sectors and compared with the measured values.

Thus, as shown in FIG. 1B, the present inventors extended the rationale for creating Y-branched pores in AAO templates by reducing the anodizing voltage by a factor of 1/\sqrt{2}, which initiates the transformation of a linear pore during anodization into a symmetrically divided “Y”. Based on this rationale, the present inventors show in one embodiment that it is possible to generate not just a single Y junction but multiple generations of Y-branching by sequentially reducing the anodizing voltage multiple times, each time by the factor of 1/\sqrt{2}. Once the complex pore structure is generated, the template is ready to be used to grow the representative nanotube or nanowire structures. For example, the nanotubes can be deposited inside the pores by the pyrolysis of acetylene without the use of any catalyst material. Once the nanotubes are grown inside the templates, the templates can be removed by selectively etching the alumina away to obtain isolated nanotubes and their arrays.

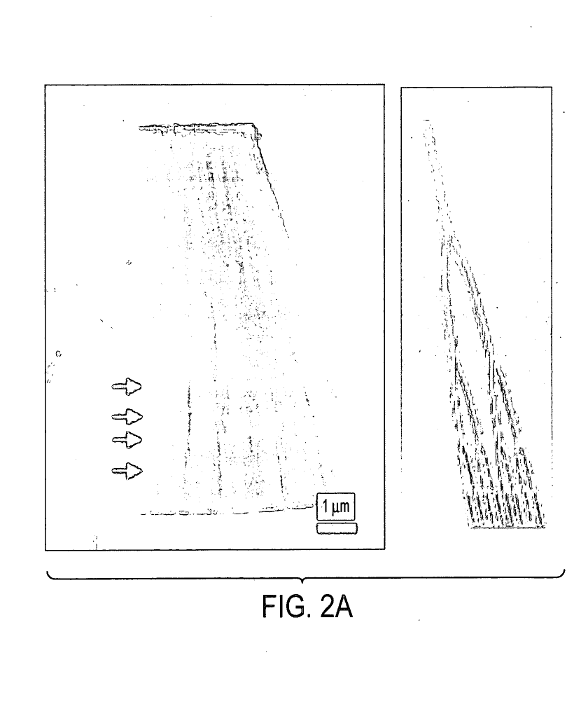

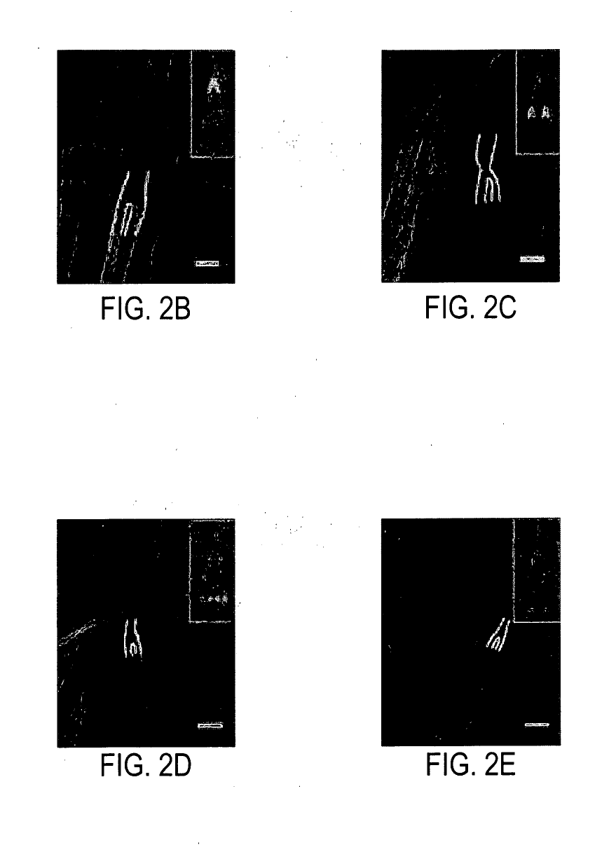

Up to four generations of Y-branching have been fabricated onto individual nanotube structures (1 [symbol] 2 [symbol] 2 [symbol] 2 [symbol] 2), as shown in the scanning electron microscope (SEM) images in FIGS. 2A-E. The right side of FIG. 2A schematically shows the structure of a typical four-level Y-branched nanotube containing a stem and four levels of branches. The left side of FIG. 2A shows a low-magnification SEM image of the branched nanotube. The image shows four parallel interfaces (marked with arrows), seen in a large bundle of nanotubes obtained after template removal, where each of the four levels of Y-branching takes place.

The high-magnification image from each of these interfaces (shown in FIGS. 2B, 2C, 2D and 2E) clearly reveals the corresponding Y-branches and the decreasing diameters of the branched nanotube segments. The Figures show the first (FIG. 2B), second (FIG. 2C), third (FIG. 2D), and fourth (FIG. 2E) “Y” levels. The Y-junction is contoured in white lines in these Figures for clarity. Insets at top right of the Figures show schematics of the whole architecture with the specific junction highlighted in white. The scale bars in these Figures are 100 nm.

The diameters of the primary stems and the branches depend on the corresponding anodizing voltages. For any two consecutive branches (at each interface), the ratio of the diameters is approximately \sqrt{2}, as seen from the Figures. The details of diameter evolution during anodization at different voltages is provided in Table I below. The diameter ratios of the smallest branch and the primary stem in several of the architectures that have been fabricated are presented in FIG. 1B. The length of each branch is controlled independently by the corresponding anodization time given for each pore segment generation.

Next, in another embodiment, the present inventors generated templates where the individual pores divide into predetermined multiple numbers of branches, such as three or more branches. The above described process allows growth of nanotubes and nanowires with a predetermined numbers of branches, such as more than two branches. The anodizing voltage controls the pore size and pore density during the anodization, since the pore diameter is proportional to the anodizing voltage. A simple calculation, based on the fact that the original total area of the template will not change during the anodization, shows that the anodizing voltage to form a number of (n) smaller branch pores from a single stem pore can be expressed as (1/\sqrt{n})×Vₛ, where Vₛ is the anodizing voltage for stem pores, and n is the number of branch pores that branch away from that stem. Based on this rationale, the present inventors have successfully prepared AAO templates with different numbers of branch pores emanating from individual stem pores and grown nanotubes in them. Once again, the precise location (depth) inside the template where the branching occurs is controlled by the sequence and timing of voltage reduction, and the branching can be made to occur abruptly or gradually based on the voltage-reduction procedure.

Thus, in reference to FIGS. 1A and 1B, a method of making a multibranched nanopore array includes anodically oxidizing a template 1 material at a first voltage to form a first level of stem nanopores 3 in the template material. The method also includes anodically oxidizing the template material at a second voltage lower than the first voltage to form a second level of branch nanopores 5 connected to the first level of stem nanopores 3. The second voltage is less than the first voltage by a factor of 1/\sqrt{n}, where n>2, to form n second level branch nanopores connected to each first level stem nanopore. This forms an ordered nanopore array in which all nanopores in each level have about a same diameter, and in which nanopores in one level have a diameter which is about 1/\sqrt{n} as large as a diameter of the nanopores in each previously formed level. Thus, for example, each stem nanopore in the first level is connected to a same number of branch nanopores in the second level, and the branch nanopores in the second level have a diameter which is about 1/\sqrt{n} as large as a diameter of the stem nanopores in the first level. n is an integer number greater than or equal to two, which equals to a number of branch pores connected to each stem pore.

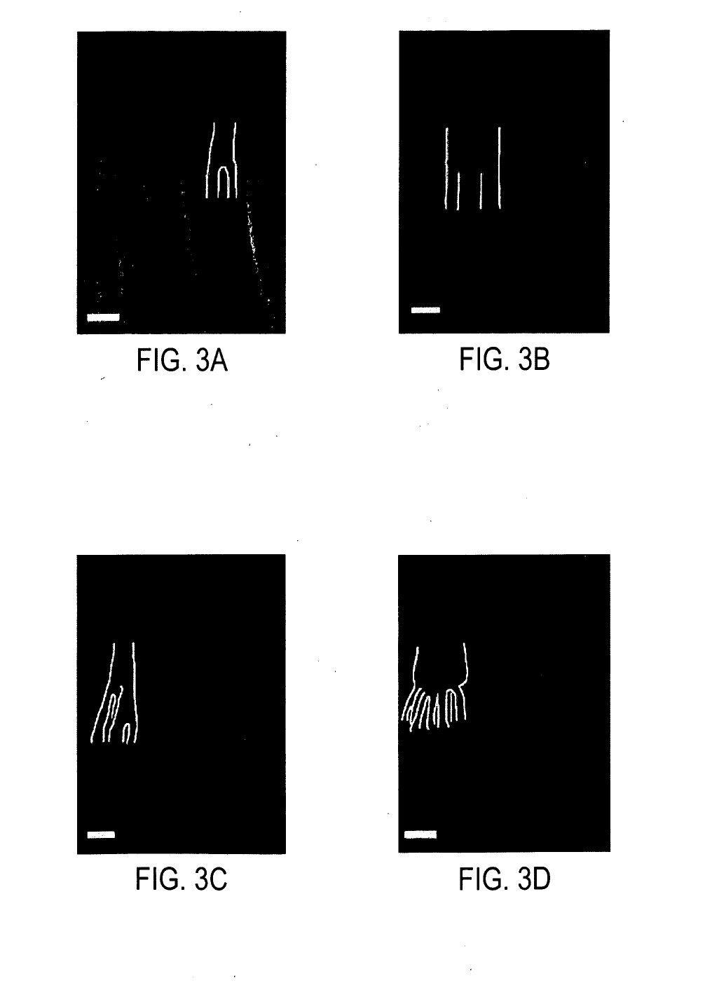

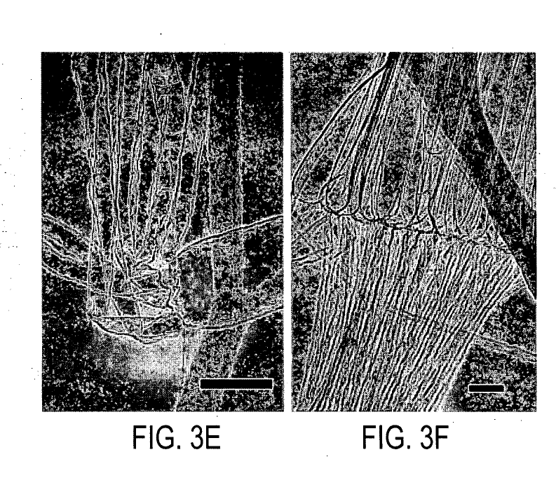

The term “about the same diameter” include exactly the same diameters and diameters which differ by a small amount due to inherent small spatial non-uniformity during anodization. FIGS. 3A-3D show nanotubes where a single stem abruptly divides into 2, 3, 4, and 16 (structures 1 [symbol] 2, 1 [symbol] 3, 1 [symbol] 4, and 1 [symbol] 16) branches, respectively. The junctions are highlighted with white line contours for clarity. In the case of the 16-branched nanotube, only half the branches are visible in the image (due to the 3D structure, the rest of the branches are behind the front visible ones). The present inventors are able to controllably produce branching numbers at will, for example, 2, 3, 4, 6, 8, and 16. The stem pore diameter mainly depends on the anodizing voltage. However, an intermediate procedure used to go from higher to lower anodizing voltages widens the stem pore diameters (seen in several images in FIGS. 3A-3D). The predicted diameters for the stems and branches come close to experimentally measured values, as provided in FIG. 1B for the experimental and calculated diameter ratios.

FIGS. 3E and 3F are the transmission electron microscopy (TEM) images of the branched nanotubes clearly showing the junctions between the larger and smaller nanotube sections. FIG. 3E is a TEM image of a nanotube with eight branches. The smaller branches appear more flexible and are shown to be easily bent. This clearly illustrates the flexibility of the smaller nanotubes. FIG. 3F is a TEM image from an array of multibranched (16 branches on each) CNTs. The scale bars in these figures are 100 nm.

In another embodiment, a combination of Y-shapes and multiple branches can lead to a wealth of new nanoscale architectures. This configuration achieved by reducing the anodizing voltages in steps, by factors of 1/\sqrt{2} and 1/\sqrt{n} (where n>2) sequentially, generating Y-shapes and n-branched pores in the template consecutively. The sequences can be interchangeable (for example, the stem can be split into multiple branches first, and each of the branches can subdivide as Y-shapes or vice versa) and recurring (several levels) so that many complicated nanostructures become possible, as illustrated for example in FIG. 1B. Continuing this approach, very complicated architectures, such as a single stem dividing into multiple branches and each of those branches further subdividing into multiple (1 [symbol] n [symbol] m) branches or structures, where n and m can be independently varied and where n and/or m can equal to 2 or can be greater than 2 can be created.

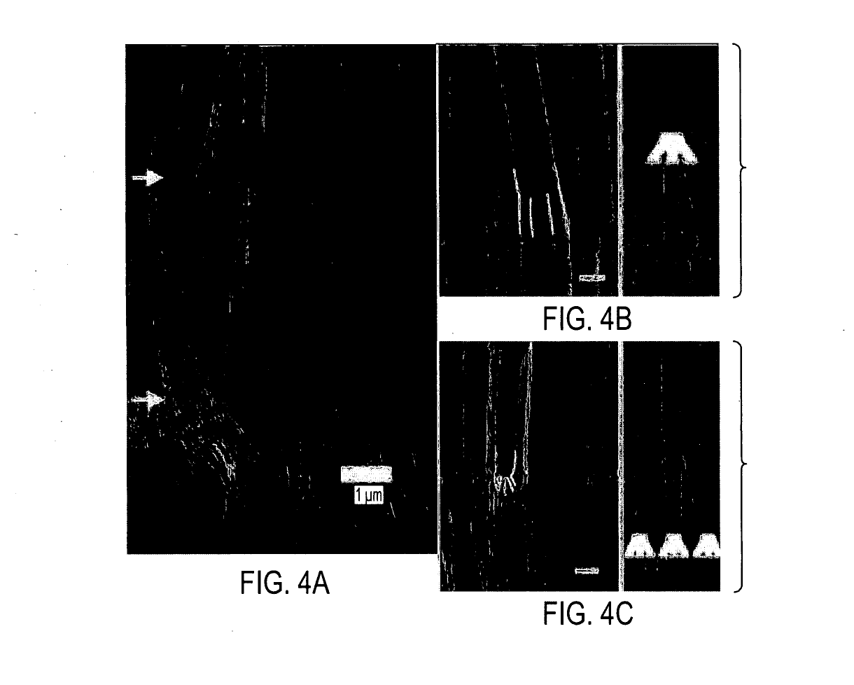

FIGS. 4A-4C show an example of such a complex structure, where two levels of multiple branching are shown (the arrows in FIG. 4A indicate the interfaces at which branching takes place). FIG. 4A is a low magnification SEM image which shown a nanotube with two levels of branching (at the locations of the white arrows). At each of the junctions, each of the stems split into three branches, giving a 1 [symbol] 3 [symbol] 3 architecture. The left portions of FIGS. 4B and 4C are close-up views of the 1 [symbol] 3 and 3 [symbol] 3 junctions, respectively. The right portions of FIGS. 4B and 4C are schematics of the location (highlighted in white) of each of the representative individual nanotube structures shown in the left portions of these figures. Junctions are highlighted with white line contours for clarity. The scale bars in FIGS. 4B and 4C are 100 nm.

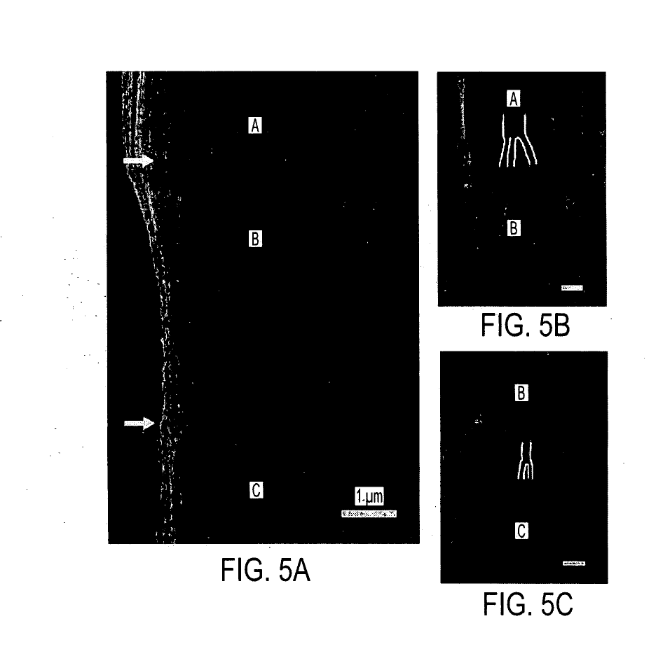

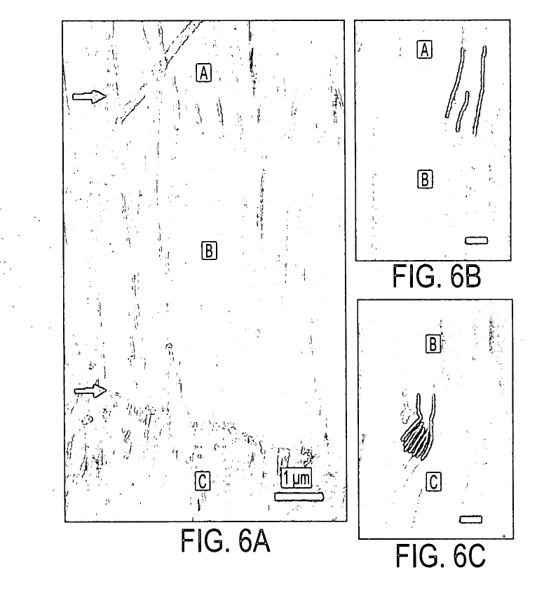

Additional branched nanostructures are shown in FIGS. 5 and 6. FIGS. 5A-5C are SEM images of complex hierarchically branched nanotube architectures having a 1 [symbol] 3 [symbol] 2 structure (denoted by “A”, “B” and “C”, respectively in the Figures). At each of the junctions (shown by white arrows in FIG. 5A), the stems split into three and two branches, respectively. FIG. 5A is a low magnification image of the entire structure. FIGS. 5B and 5C are high-magnification images which show the close-ups of the corresponding 1 [symbol] 3 junction and the 3 [symbol] 2 junction, respectively. Junctions are highlighted with white line contours for clarity. The scale bars are 100 nm for FIGS. 5B and 5C.

FIGS. 6A-6C are SEM images of complex hierarchically branched nanotube architectures of 1 [symbol] 2 [symbol] 4 structure (denoted by “A”, “B” and “C”, respectively in the Figures). At each of the junctions (shown by white arrows in FIG. 6A), the stems split into two and four branches, respectively. FIG. 6A is a low magnification image of the entire structure. FIGS. 6B and 6C are high-magnification images which show the close-ups of the corresponding 1 [symbol] 2 junction and the 2 [symbol] 4 junction, respectively. Junctions are highlighted with white line contours for clarity. The scale bars are 100 nm for FIGS. 6B and 6C.

Typically, multi-walled nanotubes are formed in the AAO templates because the smallest pore size that can be developed using AAO templates is about 10 nm, which is much greater than a single-walled nanotube diameter. However, the nanotubes made in the pores have very few walls, and, theoretically, the number of walls may be controlled (to a single layer) by controlling the deposition time. Alternatively, single-walled nanotubes (“SWNT”) or SWNT bundles may be deposited by seeding small catalyst particles within or at the bottom of the pores.

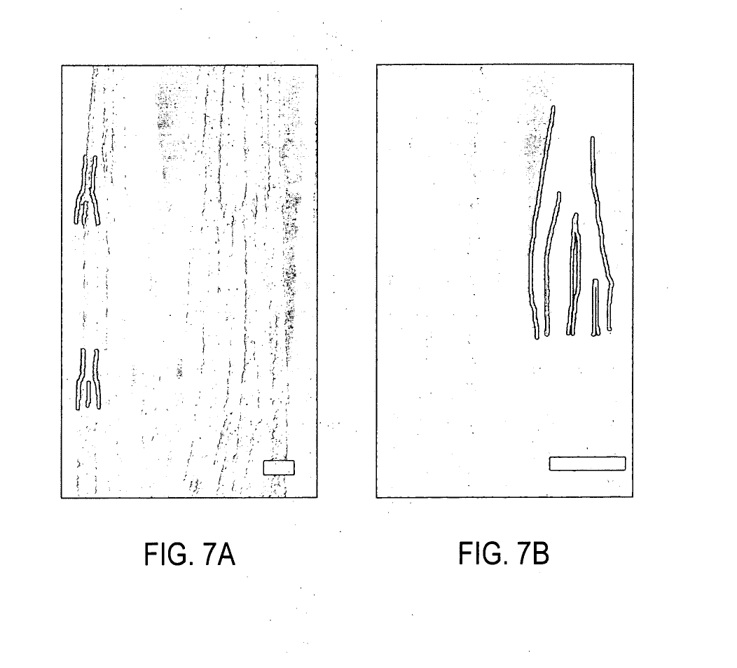

FIGS. 7A and 7B are SEM images showing hierarchically branched Ni nanowire arrays fabricated inside of complex nanochannels or nanopores in AAO using electrodeposition. FIG. 7A illustrates the Ni nanowires with a 1 [symbol] 2 [symbol] 2 structure. FIG. 7B illustrates the Ni nanowires with a 1 [symbol] 4 structure. The junctions are highlighted with white line contours for clarity. The scale bars are 200 nm.

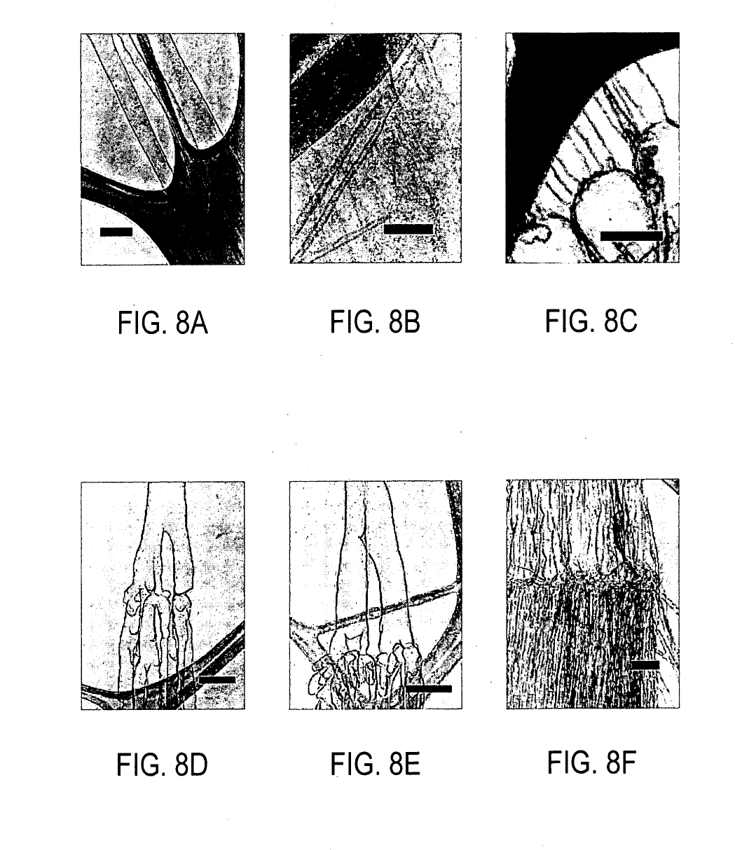

FIGS. 8A-8F are TEM images showing different junctions in hierarchically branched nanotubes that have been fabricated inside complex nanochannels or nanopores of AAO templates. FIGS. 8A and 8B illustrate “Y” branched nanotubes having different diameters. FIG. 8C shows a nanotube having one stem and three branches. FIG. 8D shows one stem gradually (not abruptly) changing into eight branches. Some rough morphology is seen on the tube walls due to roughness in the pores resulting from instabilities in anodizing current. FIG. 8E shows a nanotube having a 1 [symbol] 2 [symbol] 4 structure. FIG. 8F shows an array of larger stems turning into multiple small branches (>10). The junctions formed by these various stems and branches are clearly seen in the micrographs. All scale bars are 100 nm.

Thus, by using the templates with tailored pores, various nanostructures, such as nanotubes and nanowires can be grown. This use of the tailored pores in a template material serves as a generic method for creating complex nanowires of most materials that can either be deposited by means of vapor phase deposition or electrodeposition. The following references, which are incorporated herein by reference in their entirety, describe nanostructure deposition by vapor phase deposition: Li, J., Papadopoulos, C. & Xu, J. (1999) Nature 402, 253-254; Davydov, D. N., Sattari, P. A., AlMawlawi, D., Osika, A., Haslett, T. L. & Moskovits, M. (1999) J. Appl. Phys. 86, 3983-3987; and Sui, Y. C., Cui, B. Z., Martinez, L., Perez, R. & Sellmyer, D. J. (2002) Thin Solid Films 406, 64-69. The following references, which are incorporated herein by reference in their entirety, describe nanostructure deposition by electrodeposition: Martin, C. R. (1994) Science 266, 1961-1966; Routkevitch, D., Tager, A. A., Haruyama, J., Almawlawi, D., Moskovits, M. & Xu, J. M. (1996) IEEE Trans. Electron Devices 43, 1646-1658; Huczko, A. (2000) Appl. Phys. A 70, 365-376; Schmid, G. (2002) J. Mater. Chem. 12, 1231-1238; and Choi, J., Sauer, G., Nielsch, K., Wehrspohn, R. B. & Gosele, U. (2003) Chem. Mater. 15, 776-779.

Insulating, semiconducting, and polymeric materials also may be controllably synthesized into the complex nanowires by using the above templates with infiltration processes described in the above references and in Kovtyukhova, N., Mallouk, T. E. & Mayer, T. (2003) Adv. Mater. 15, 780-785; and Park, S., Lim, J. H., Chung, S. W. & Mirkin, C. A. (2004) Science 303, 348-351.

In another embodiment, in addition to single-component nanowire and nanotube architectures, it also should be possible to make hetero-nanowire junctions, for example by electrodepositing metal nanowires in the stems and then growing nanotubes or other material nanowires as the branches. Thus, the stem comprises one of nanowire or nanotube material and the branches comprise the other one of nanowire or nanotube material. Alternatively, the stem and the branches may comprise nanowires of a different material composition and/or structure. This configuration includes different level branches having a different material composition and/or structure, where the lower branches are viewed as the stems for the upper branches. In multilevel nanostructures, the stem and each level of branches may be made of a different material composition and/or structure.

For example, the stem may comprise a nanowire made of one metal, polymer, semiconductor or other insulating material which the branches may comprise a nanowire made of a different metal, polymer, semiconductor or other insulating material. This difference in material composition may be embodied in a different type of material (for example, metal stem and polymer branches) or in different materials of the same type (for example, GaAs semiconductor stem and InGaAs semiconductor branches).

Furthermore, the difference in composition may be embodied in a different doping composition or concentration of the stem and branches. Thus, the stem and branches may comprise the same nanowire or nanotube material, but doped with a different dopant and/or containing a different concentration of the same dopant and/or where one of the stem or branches is undoped and the other one is doped.

For example, in a Y-branched semiconductor nanowire or semiconductor nanotube, the stem can be low doped with a dopant of one conductivity type (i.e., p or n) and the two branches can be highly doped with a dopant of the opposite conductivity type (i.e., n or p). In this case, the nanostructure acts as a p-n-p or n-p-n diode or as a bipolar transistor. Alternatively, the stem acts as the channel and the branches act as source and drain regions of a field effect transistor with an additional gate electrode being provided near or around the channel stem. In this case, the stem may be low doped and the branches may be highly doped. The branches are then connected to separate electrodes. A 1 [symbol] 3 nanowire structure may act as a complete field effect transistor with the middle branch acting as a gate electrode, the end branches acting as source and drain regions and the stem acting as a channel, if the middle branch can be formed to avoid physical contact with the end branches. It may be desirable to implement a separate doping step to dope the “gate” branch with an opposite conductivity dopant type from the “source and drain” branches.

For multilevel nanowires and semiconductor nanotubes, the middle level branches may have one doping type (p or n) to act as a middle of a diode, or as a base of a bipolar transistor, or as a channel of a field effect transistor, and the stem and the upper level branches may have an opposite doping type (i.e., n or p) to act as ends of a two junction diode, or as emitter and collector regions of a bipolar transistor, or as source and drain regions of a field effect transistor. A separate gate electrode may be provided near or around the middle level branch of the structure to complete the field effect transistor. Of course the stem and branches may also be made of different semiconductor materials to make a heterojunction diode or transistor if desired.

Alternatively, the stem and the branches may be made of the same material but may have a different structure. Different structure includes different crystal structure, different grain size for polycrystalline nanowires, different number of walls for multi-walled nanotubes, different chiralities for nanotubes, etc.

In summary, a powerful, rational, synthetic approach for the design and fabrication of hierarchical nanopore/nanostructure architectures is provided. The nanopore architectures should complement materials, such as zeolites, that contain interconnected ordered pore frameworks of different dimensionality, chemistry, and structure. The rational approach for creating hierarchically branched ordered nanoporous AAO templates allows fabrication of a whole generation of branched nanowires and nanotubes inside these templates.

The nanostructures described herein should open up new opportunities for both fundamental research and building of various nanoscale architectures for applications. The hierarchically branched nanotube/nanowire constructs with tree-like morphology could impart similar functions as polymer dendrimers, which are used to build large supramolecular constructs for applications such as drug delivery. In other words, the individual branches can be differentially chemically functionalized and terminated to create complex multiple chemical sensors in one unit. Such constructs also can be the core structure to build complex nanoscale biomaterials. The multiply branched nanotube/nanowire architectures could be key to building components of complex nanoelectronics circuits and nanoelectromechanical systems.

It should be noted that the branched nanopore arrays may be used without growing the nanostructures, such as nanotubes or nanowires in the nanopores. For example, the ordered straight pore arrays of traditional AAO templates have been used effectively to build flow-through-type DNA arrays. The template structures with hierarchically branched nanopores may have applications in biotechnology, such as nanoscale separation technologies, and in fundamental diffusion studies where the multiply divided pores can act as selective barriers in a multicomponent diffusion process.

The following exemplary materials and methods are provided for illustration of the embodiments of the invention should not be considered to be limiting on the scope of the invention.

Preparation of Templates. Anodically oxidized alumina (“AAO”) is a preferred template material. However, other metals, such as scandium or niobium, which can be anodically oxidized to form a controlled nanopore array can be used. In the specific examples of the present invention, AAO templates are prepared by using a two-step anodization process. The first-step anodization is the same for all templates. High-purity Al foils are anodized in 0.3 M oxalic acid solution at 8-10° C. under a constant voltage (in the range of 40-72 V_{dc}) for 8 h. Then, the formed anodic aluminum layer is removed. In the second-step anodization, templates with different pore architectures undergo different processes of anodization as follows.

AAO Templates with Multiple Levels or Generations of Y-Branched Pores. The anodizing voltage is reduced multiple times (i.e., more than twice) in the second-step anodization. Initially, the anodization is performed under the same conditions as those in the first step to create the primary stem pores. Then, the anodizing voltage is reduced by a factor of 1/\sqrt{2} to form Y-branched pores (i.e., a stem pore connected to two branch pores). Two-, three-, and four-generation or level Y-branched pores can be obtained by further sequential reduction of anodizing voltages by a factor of 1/\sqrt{2}, over prior voltages. It is noted that if a subsequent anodizing voltage is ≦25 V, after any prior anodization, the samples should be washed in deionized water for about 30 min. to clean the remaining oxalic acid solution in the pores, and then the anodization should be conducted in 0.3 M sulfuric acid at the same temperature used previously.

AAO Templates with Multiply Branched Pore Structure. To form templates with three or more branch pores for each stem pore, after the initial anodization to form the stem pores, the anodizing voltage is reduced by a factor of 1/\sqrt{n} to create multiply branched pores containing n branches. For n>2, there are more than two branch pores for each stem pore. If the voltage is reduced slowly, the stem pores divide branched pores gradually (at several depths), but if the voltage is reduced suddenly, the stem pores will be divided abruptly (sharp interface). Typically, after the anodization for the stem pores, the remaining oxalic acid solution in the pores is cleaned in deionized water and the barrier layer at the pore bottom is thinned by immersing the samples in a 5% (wt) phosphoric acid solution at 31° C. for 30-70 min. It should also be noted that if the anodizing voltage for branched pores is ≦25 V, a 0.3-M sulfuric acid electrolyte should be used instead of oxalic acid.

AAO Templates with Several Levels of Multiply Branched Pores. To form templates with three or more branch pores for each stem pore and with two or more levels or branch pores, after the initial anodization for primary stem pores, the anodizing voltage is reduced by a factor of 1/\sqrt{n} to create first-generation multibranched (n) pores, and the anodizing voltage is subsequently reduced again by a factor of 1/\sqrt{m}, to generate the second-generation multibranched pores growing from each of the first-generation multibranched pores. The numbers n and m are integers which are equal to or are greater than 2. n may be equal to or not equal to m. Thus, n may be greater than, less than or equal to m. At least one of n or m may be greater than 2, such as 3 to 16, for example. Preferably, but not necessarily, both n and m are greater than 2.

Growth of Carbon Nanotubes in AAO Template. Multiwalled carbon nanotubes are grown inside the pores of the AAO templates by the pyrolysis of acetylene at 650° C. for 1-2 hours with a flow of gas mixture of Ar (85%) and C₂H₂ (15%) at a rate of 35 ml/min. The nanotubes are multiwalled (having about 4 to 10 walls), have a diameter in a range of about 20 to about 120 nm, and are graphitic in nature. From the observations of several branched multiwalled nanotube structures presented herein, the wall thickness (and hence the number of walls) falls within a very narrow range of about 1-4 nm. The present inventors normally observe a small reduction in the number of walls (approximately two or three walls) as a larger tube changes into smaller ones, and this reduction seems to happen quite abruptly.

It should be noted that other suitable process conditions may be used. Furthermore, other carbon containing source gases, such as ethylene for example, may be used instead of acetylene to deposit the nanotube using the chemical vapor deposition process. Finally processes other than chemical vapor deposition, such as laser ablation for example, may be used.

Electrochemical Deposition of Ni Nanowires in AAO Template. Nickel nanowires are grown inside the pores by the following method. It should be noted that while nickel is used as an example, nanowires made from other metal or non-metal materials may be used instead. After the final anodization, the remaining Al layer at the bottom of AAO templates is removed in a saturated SnCl₄ solution. Before removing the barrier layer, the top surface of the templates is covered with nail polish to protect the pores if the barrier layer is thinned before the anodization for the branched pores. An adhesion layer of Ti (10 nm) and Cu film (1 μm) is coated onto the stem pore side of the AAO templates (i.e., the back side of the template) by electron-beam evaporation to cover the pores completely and to serve as the working electrode in electrochemical deposition. Ni nanowires are electrodeposited into the pores of AAO templates by using standard electrodeposition procedures described in Whitney, T. M., Jiang, J. S., Searson, P. C. & Chien, C. L. (1993) Science 261, 1316-1319, incorporated by reference in its entirety. It should be noted that other nanowire growth methods may be used instead.

Template Removal. Nanotubes are released from AAO templates by dissolving the templates in a 20% (wt) HF solution for 12 h, and then washing with deionized water several times. Ni nanowires are released from AAO templates by immersing the templates in a 10% (wt) NaOH solution for 1 h, and then washing with deionized water several times. For other nanowire materials, selective etching solutions other than NaOH which selectively etch the anodized aluminum (i.e., aluminum oxide) over the nanowire material may be used instead.

Without wishing to be bound by a particular theory, the present inventors believe that the pore diameter developed inside the template depends on the following three processes:

1. For the anodization process, the pore diameter is proportional to the anodizing voltage, and the diameter attributed by the anodization can be expressed as D_{κ}×I′ (nm), where V refers to the anodizing voltage, and _{κ} is a constant (nmV⁻¹) as reported, for example, in O'Sullivan, J. P. & Wood, G. C. (1970) Proc. R. Soc. London A 317, 511-543; Furneaux, R. C., Rigby, W. R. & Davidson, A. P. (1989) Nature 337, 147-149; Broughton, J. & Davies, G. A. (1995) J. Membr. Sci. 106, 89-101; and Choi, J., Sauer, G., Nielsch, K., Wehrspohn, R. B. & Gösele, U. (2003) Chem. Mater. 15, 776-779.
2. Thinning the barrier layer process before further anodization for multibranched pores also widens the existing pores. The diameter increase depends on the pore widening rate and thinning barrier layer time.
3. Removing the barrier layer in the final process of template preparation also will increase the pore diameter if the top surface is not covered with nail polish. The diameter increase depends on the pore widening rate and removing barrier layer time.

Templates with different pore structures undergo different processes, so the final diameters of the pores (and correspondingly, the outer diameter of the grown nanotubes or other nanostructures) in different structured templates can be calculated separately.

The diameter ratios of the nanotube structures (ratio of the smallest diameter of the highest or final branch level to the stem diameter) that are produced experimentally are provided in Table I, below. Both theoretically calculated ratios and experimentally observed values are shown, and there is an good correspondence between them.

TABLE I

| | | Calculated |
|---|---|---|
| | | from |
| | Measured | anodizing |
| Architectures | from SEM | voltage |
| 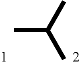 | 48.3/66.2 = 0.73 | 0.70 |
| 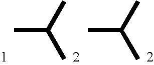 | 36.4/66.2 = 0.55 | 0.49 |
| 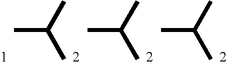 | 23.4/66.2 = 0.35 | 0.34 |
| 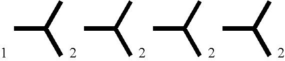 | 16.6/66.2 = 0.25 | 0.24 |
| 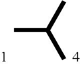 | 41.7/83.3 = 0.50 | 0.50 |
| 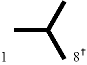 | 31.2/120 = 0.26 | 0.35 |
| 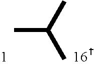 | 28.0/130 = 0.22 | 0.25 |
| 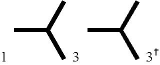 | 33.0/150 = 0.22 | 0.33 |
| 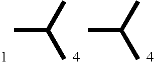 | 15.0/60 = 0.25 | 0.24 |
| 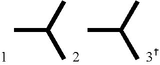 | 27.8/69.4 = 0.40 | 0.42 |
| 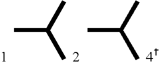 | 30.0/83.3 = 0.36 | 0.34 |
| 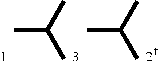 | 40.9/95 = 0.43 | 0.40 |
| 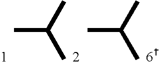 | 30.8/102.6 = 0.30 | 0.30 |

In Table I, the anodizing voltage for the primary stem is about 70 V for all architectures. In the second column of Table I, the first two numbers are average values of diameters (in nanometers). For the structures marked with the “^{∀}” symbol in Table I, an intermediate step (thinning barrier layer process) produced widening of the primary stem.

Although the foregoing refers to particular preferred embodiments, it will be understood that the present invention is not so limited. It will occur to those of ordinary skill in the art that various modifications may be made to the disclosed embodiments and that such modifications are intended to be within the scope of the present invention. All of the publications, patent applications and patents cited herein are incorporated herein by reference in their entirety.

1. A branched nanostructure, comprising at least one of:
(a) a stem and at least two levels of branches; or
(b) a stem connected to three of more branches; or
(c) a nanowire nanostructure comprising a stem and two or more branches; or
(d) a stem connected to two or more branches, wherein the stem and the branches comprise a different material composition or structure.

2. The nanostructure of claim 1, wherein the nanostructure is formed by a method comprising:
forming the nanostructure in a branched nanopore located in a template material; and
selectively removing the template material.

3. The nanostructure of claim 1, wherein:
the nanostructure comprises a stem and at least two levels of branches; and
the branches in the first level of branches are connected to the stem and to the branches in the second level of branches.

4. The nanostructure of claim 3, wherein the nanostructure comprises a carbon nanotube nanostructure.

5. The nanostructure of claim 3, wherein the nanostructure comprises a nanowire nanostructure.

6. The nanostructure of claim 1, wherein the nanostructure comprises a stem connected to three of more branches.

7. The nanostructure of claim 6, wherein:
each of the branches connected to the stem are located in a first level of branches; and
each of the branches in the first level of branches is connected to two or more branches in a second level of branches.

8. The nanostructure of claim 6, wherein the nanostructure comprises a carbon nanotube nanostructure.

9. The nanostructure of claim 6, wherein the nanostructure comprises a nanowire nanostructure.

10. The nanostructure of claim 1, wherein the nanostructure comprises a nanowire nanostructure comprising a stem and two or more branches.

11. The nanostructure of claim 10, wherein the nanowire material comprises a metal, a semiconductor, a metal oxide, a polymer or an insulating material other than carbon.

12. The nanostructure of claim 10, wherein:
each of the branches connected to the stem are located in a first level of branches; and
each of the branches in the first level of branches is connected to two or more branches in a second level of branches.

13. The nanostructure of claim 10, wherein the nanostructure comprises a stem connected to three of more branches.

14. The nanostructure of claim 1, wherein the stem and the branches comprise a different material composition.

15. The nanostructure of claim 14, wherein the stem comprises one of nanowire or nanotube material and the branches comprise the other one of nanowire or nanotube material.

16. The nanostructure of claim 1, wherein the stem and the branches comprise a different material structure.

17. The nanostructure of claim 1, wherein:
the stem and the branches comprise a different material composition or structure; and
the nanostructure comprises at least one of the stem and at least two levels of branches, or the stem is connected to three or more branches.

18. The nanostructure of claim 1, wherein the nanostructure comprises a diameter of 200 nm or less.

19. A method of making the nanostructure of claim 1, comprising:
providing a branched nanopore array in a template material;
forming an array of the nanostructures of claim 1 in nanopores of the nanopore array; and
selectively removing the template material.

20. An ordered nanopore array, comprising:
a template material and two or more levels of ordered nanopores;
a first level of nanopores comprises stem nanopores;
a second level of nanopores comprise branch nanopores, such that at least two branch nanopores in the second level of nanopores are connected to each stem nanopore in the first level of nanopores; and
further comprising at least one of:
(a) a third level of nanopores comprising branch nanopores, such that at least two branch nanopores in the third level of nanopores are connected to each branch nanopore in the second level of nanopores; or
(b) at least three branch nanopores in the second level of nanopores are connected to each stem nanopore in the first level of nanopores.

21. The nanopore array of claim 20, wherein:
the template material comprises alumina;
each stem nanopore in the first level is connected to a same number of branch nanopores in the second level;
all nanopores in each level have about a same diameter;
the branch nanopores in the second level have a diameter which is about 1/\sqrt{n} as large as a diameter of the stem nanopores in the first level;
n is an integer greater than or equal to two; and
n equals to a number of branch nanopores connected to each stem nanopore.

22. A method of making a nanopore array, comprising:
anodically oxidizing a template material at a first voltage to form a first level of stem nanopores in the template material;
anodically oxidizing the template material at a second voltage lower than the first voltage to form a second level of branch nanopores connected to the first level of stem nanopores; and
anodically oxidizing the template material at third voltage lower than the second voltage to form a third level of branch nanopores connected to the second level of branch nanopores.

23. The method of claim 22, wherein:
the second voltage is less than the first voltage by a factor of 1/\sqrt{n}, where n>2, to form n second level branch nanopores connected to each first level stem nanopore; or
the third voltage is less than the second voltage by a factor of 1/\sqrt{n}, where n>2, to form n third level branch nanopores connected to each second level branch nanopore.

24. The method of claim 22, further comprising forming an array of branched nanostructures in the nanopores and selectively removing the template material.

25. A method of making a nanopore array, comprising:
anodically oxidizing a template material at a first voltage to form a first level of stem nanopores in the template material; and
anodically oxidizing the template material at a second voltage lower than the first voltage to form a second level of branch nanopores connected to the first level of stem nanopores; wherein the second voltage is less than the first voltage by a factor of 1/\sqrt{n}, where n>2, to form n second level branch nanopores connected to each first level stem nanopore.

26. The method of claim 25, further comprising forming an array of branched nanostructures in the nanopores and selectively removing the template material.
